(19) United States
(12) Patent Application Publication
(10) Pub. No.: US 2008/0186823 A1
(43) Pub. Date: Aug. 7, 2008

(54) METHOD AND APPARATUS FOR DEFECT DETECTION

(75) Inventors: Chin-Huo Chu, Koahsiung Hsien (TW); Chun-Ying Chiang, Chiayi City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/550,536

(22) Filed: Oct. 18, 2006

(51) Int. Cl. G11B 5/58

(52) U.S. Cl. 369/53.17

(57) ABSTRACT

A defect detection system, defect detection method and disc verification method for rewritable optical discs are provided A demodulator reads an optical disc to obtain a plurality of sectors corresponding to an ECC block along with parity inner (PI) and parity outer (PO) codes. A sector detector, coupled to the demodulator, decodes the PI codes to obtain defect information of the sectors. A memory is coupled to the sector detector, storing contents and defect information of the sectors. An ECC block detector decodes the PO codes, and determines defectiveness of the ECC block based on the defect information and the PO codes. A processor controls the PI and PO decoding procedures and a further PDL/SDL update procedure.

### BACKGROUND OF THE INVENTION

1. Field of the Invention

The invention relates to DVD-RAM, and in particular, to defect management for a DVD-RAM disc.

2. Description of the Related Art

For rewritable optical discs such as DVD-RAM, data is not written to sectors in which read-out errors are detected beyond a predetermined level (hereinafter referred to as “defective” sectors) to achieve high reliable write/reproduction operation. To accomplish this, defect management is performed such that addresses of defective sectors are stored in a defect management table on the optical disc and data access to the defective sectors, write or read-out, is prohibited.

FIG. 1 shows a conventional data structure of a sector block 100 according to the DVD-RAM specification. A total of 2064 bytes are arranged in 12 rows containing each 172 bytes. The first row begins with three fields, Data ID, ID error detection code (IED), and reserved bytes, followed by 160 user data bytes. The Data ID records a unique serial number of the sector. The next 10 rows each contain 172 user data bytes, and the last row contains 168 user data bytes followed by four bytes recording an error detection code (EDC). A total of 2048 bytes of user data is identified as 0 to 2047 in FIG. 1.

FIG. 2 shows an ECC block 200 according to the DVD-RAM specification. The ECC block 200 is formed by arranging 16 consecutive scrambled blocks in 192 rows of 172 bytes each. A scrambled block is generated from the sector block of FIG. 1 through a scramble circuit. To each of the 172 columns, 16 bytes of Parity of Outer code (PO) are added, and to each of the resulting 208 rows, 10 bytes of Parity Inner Code are added. Thus a complete FCC block comprises 209 rows of 182 bytes each. The PO and PI codes are generated by Reed-Solomon algorithm, providing fault tolerance for each column and row. In the ECC block 200, each row is also referred to as a frame, an elementary data unit.

Conventionally, defect management is accomplished by primary defect list (PDL) and secondary defect list (SDL) located in reserved areas of a DVD-RAM disc. The PDL records defective sectors, and the SDL records defective FCC blocks. A sector is deemed defective if more than a first number of its rows fail the PI check. An ECC block is deemed defective if more than a second number of its sectors are defective. Besides, an ECC block may be deemed defective if more than a number of its columns fail the PO check. Specifically, each sector is assigned with a unique address PID (physical identification), and PID of a sector is written to the PDL when a defect is detected thereon. PID of one ECC block is represented by PID of the first sector in that ECC block. When an ECC block is determined defective, PID thereof is recorded in the SDL along with PID of a replacement ECC block, such that a substitution is provided for the defective ECC block. The PID is also provided with error tolerance by four fields PID1, PID2, PID3, PID4 at four different locations within a sector (not shown). If more than three PID fields readout in one sector are erroneous, it is referred to as a header error, and the sector is also deemed defective.

The PDL and SDL are initially established when a DVD-RAM disc is produced. New defects may occur to the recording surface after using, thus a verification mechanism is desirable to keep the PDL and SDL updated when performing a format or a write operation on the DVD-RAM disc.

### BRIEF SUMMARY OF THE INVENTION

A detailed description is given in the following embodiments with reference to the accompanying drawings.

An exemplary embodiment of a defect detection system for rewritable optical discs is provided. A demodulator reads an optical disc to obtain a plurality of sectors corresponding to an ECC block along with parity inner (PI) and parity outer (PO) codes. A sector detector, coupled to the demodulator, decodes the PI codes to obtain defect information of the sectors. A memory is coupled to the sector detector, storing contents and defect information of the sectors. An ECC block detector decodes the PO codes, and determines defectiveness of the ECC block based on the defect information and the PO codes. A processor controls the PI and PO decoding procedures and a further PDL/SDL update procedure.

The sector detector comprises a PI decoder verifying contents of the sectors based on the PI codes, a header decoder extracting headers from the sectors to verify correctness thereof, and a sector verifier calculating the verification results from the PI decoder and header decoder. The sector verifier also determines whether a sector is defective based on the calculation and a first threshold. A sector comprises a plurality of frames each associated with a PI code. The PI decoder determines the defectiveness of the frames based on the corresponding PI codes, and calculates a defect frame number for each sector. If the defect frame number of a sector exceeds the first threshold, the sector is deemed defective. The first threshold is a programmable value implemented by software.

The ECC block detector comprises a PO decoder reading the sectors from the memory to decode the PO codes, and calculating a PO error number, a defect list maintaining the defectiveness determination results of the sectors within the ECC block, and an ECC block verifier reading the defect list to calculate defect sector numbers. The ECC block verifier determines whether the ECC block is defective by comparing the defect sector number and a second threshold. When the ECC block is deemed defective, the ECC block verifier delivers an interrupt to the processor to update a PDL or a SDL of the optical disc, and simultaneously, the ECC block verifier delivers a control signal to suspend the PO decoder until the processor completes the update. If the defect sector number exceeds the second threshold, the ECC block is deemed defective. The second threshold is a programmable value implemented by software.

Another embodiment provides a defect detection method and a disc verification method implemented in the defect detection system. The disc verification method comprises the following steps. A plurality of sectors corresponding to an ECC block along with parity inner (PI) and parity outer (PO) codes are sequentially obtained from a rewritable optical disc. Defectiveness of the ECC block is checked by the defect detection method. If an error is found, an interrupt is delivered to trigger an update process. The update process comprises, if the disc verification method is performed in format mode, checking whether a PDL in the rewritable optical disc is fill, if not, updating the PDL to record defect sectors in the ECC block, otherwise, updating the SDL to record the defect ECC block. If the disc verification method is performed in write mode, the SDL is updated to record the defect ECC block.

### BRIEF DESCRIPTION OF THE DRAWINGS

The invention can be more fully understood by reading the subsequent detailed description and examples with references made to the accompanying drawings, wherein:

FIG. 1 shows a conventional data structure of a sector block according to the DVD-RAM specification,

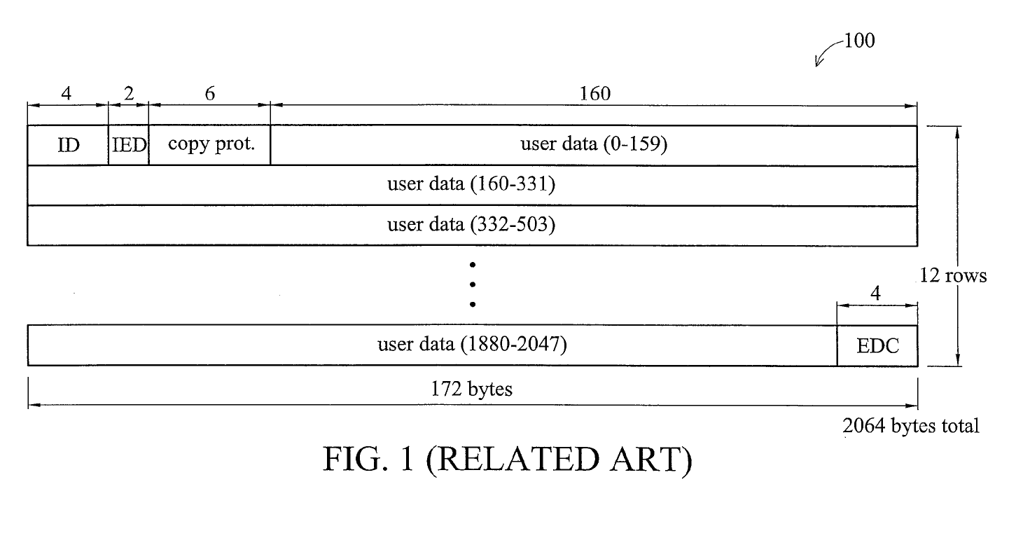

FIG. 2 shows an ECC block according to the DVD-RAM specification,

FIG. 3 shows an embodiment of a defect management system for DVD RAM;

FIG. 4 shows an embodiment of the sector detector 304 in FIG. 3;

FIG. 5 shows an embodiment of the ECC block detector 308 in FIG. 3;

FIG. 6 is a flowchart of sector verification performed by the sector detector 304;

FIG. 7 is a flowchart of ECC block verification performed by the ECC block detector 308, and

FIG. 8 is a flowchart of disc verification process according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

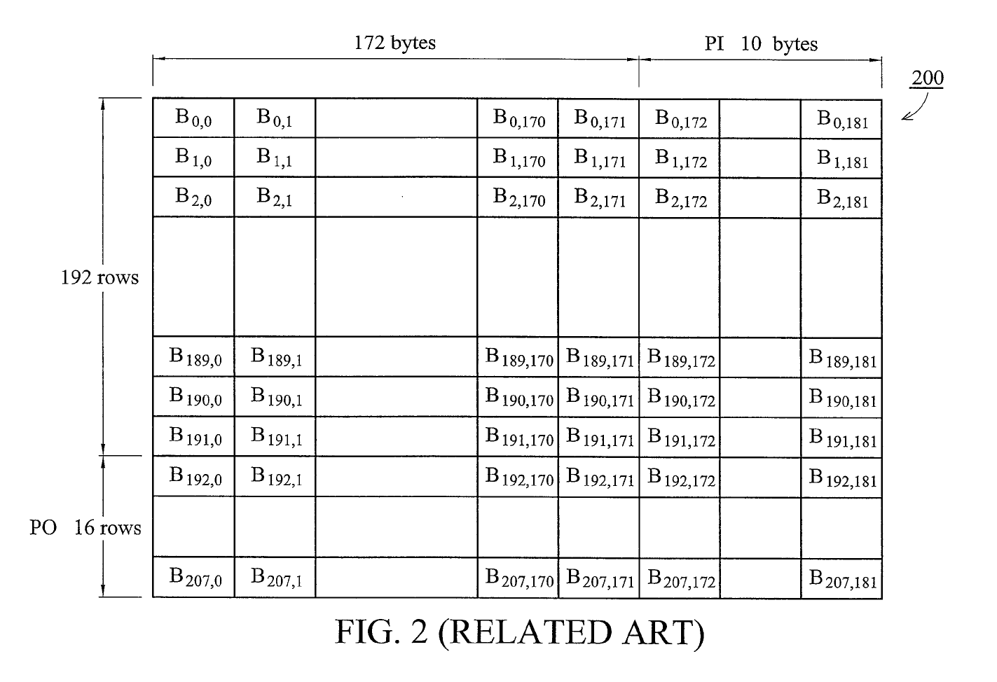

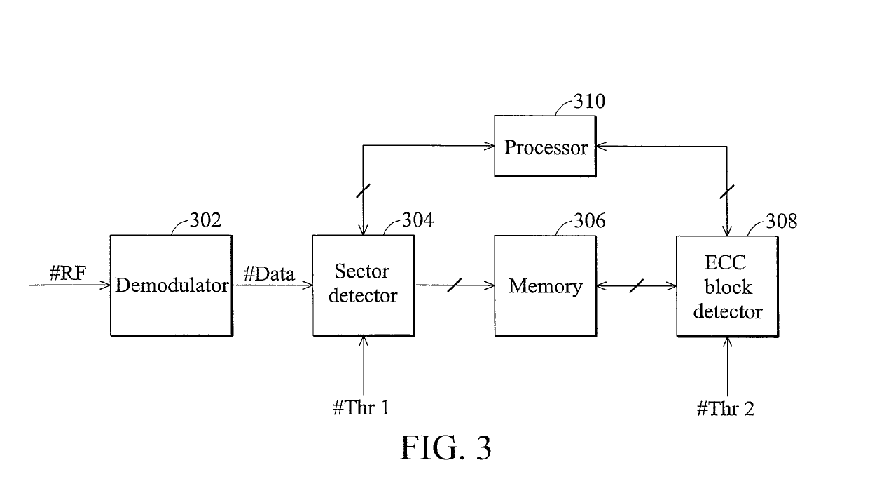

FIG. 3 shows an embodiment of a defect management system for DVD RAM discs. The demodulator 302 de-multiplexes(or demodulates) eight-fourteen modulated (EFM) signals from pickup head (not shown) to obtain a digital data stream as shown in FIG. 2, and the sector detector 304 receives the digital data stream to perform sector verification. The digital data stream represents a plurality of consecutive frames corresponding to one ECC block. An ECC block comprises sixteen sectors, and a sector comprises twelve frames each attached with a 10 bytes PI code. The sector detector 304 sequentially extracts the digital data stream frame by frame, such that defectiveness of the sectors is examined according to the PI codes. The memory 306 buffers the digital data stream with the defect information for later use, such as PO decoding. The ECC block detector 308 then reads the memory 306 to perform the PO decoding, and determines defectiveness of the ECC block based on the defect information and the PO codes. A first threshold #thr1 decides how many defective frames determines a defective sector, and a second threshold #thr2 how many defective sectors lead to a defective ECC block. The processor 310 executes firmware or programs to perform PDL/SDL managements, and controls the operations of the sector detector 304 and the ECC block detector 308.

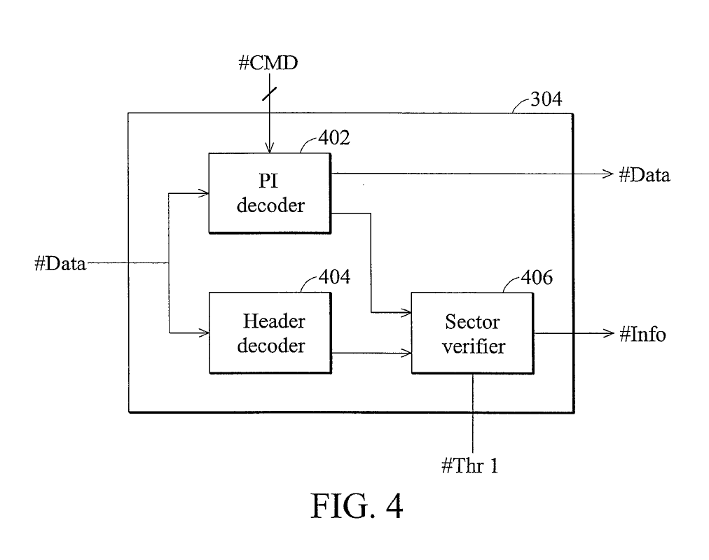

FIG. 4 shows an embodiment of the sector detector 304 in FIG. 3. A PI decoder 402 verifies contents of the sectors based on the PI codes. Specifically, the PI decoder 402 determines the defectiveness of the frames based on the corresponding PI codes, and calculates a defect frame number for each sector. A header decoder 404 extracts headers from the sectors to verify correctness thereof The sector verifier 406 calculates the verification results of the PI decoder 402 and header decoder 404 to determine whether a sector is defective based on the first threshold #thr1. If the defect frame number of a sector exceeds the first threshold #thr1, the sector is deemed defective. The first threshold #thr1 may be a programmable value implemented by software. Defect information of each sector is then obtained and stored to the memory 306 along with its contents. For example, the defect information may comprise a 13-bit map representing conditions of the thirteen frames within one sector, with 0 representing normal and 1 defective. The defect information may also comprise a PDL flag indicating whether the sector is deemed defective, and PID of the sector.

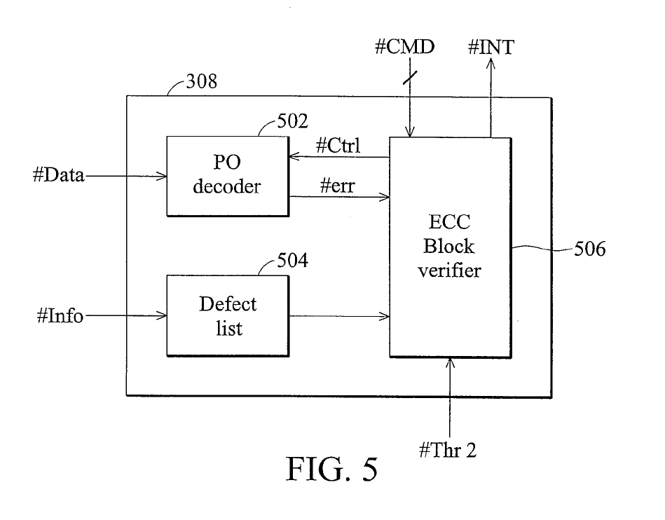

FIG. 5 shows an embodiment of the ECC block detector 308 in FIG. 3. Since PO decoding requires a complete ECC block, it is not performed until a complete ECC block is reorganized from sequentially obtained frames in the memory 306. The PO decoder 502 then reads the sectors from the memory 306 to perform PO coding, and if an error is found, a PO error number is calculated. A defect list 504 is established to maintain the defectiveness determination results of the sectors. The defect list 504 may be implemented by registers, or a memory block allocated in the memory 306. The defect list 504 can be a 16 bit map representing conditions of sixteen sectors within one ECC block, with 0 representing normal, and 1 defective. Other essential information such as PID of each sector may also be recorded in the defect list 504. An ECC block verifier 506 is coupled to the PO decoder 502 and defect list 504, reading the defect list 504 to calculate total defect sector number, and determining whether the ECC block is defective by comparing the defect sector number with a second threshold #thr2. For example, if the defect sector number exceeds the second threshold #thr2, the ECC block is deemed defective. Alternatively, if the PO error number counted by the 502 exceeds an unrecoverable range, the ECC block is also deemed defective. The second threshold #thr2 may also be a programmable value implemented by software. When the ECC block is deemed defective, the ECC block verifier 506 delivers an interrupt #INT to the processor 310 to trigger a further PDL/SDL management procedure, and simultaneously, the ECC block verifier 506 delivers a control signal #ctrl to suspend the PO decoder 502 until the processor 310 completes the procedure.

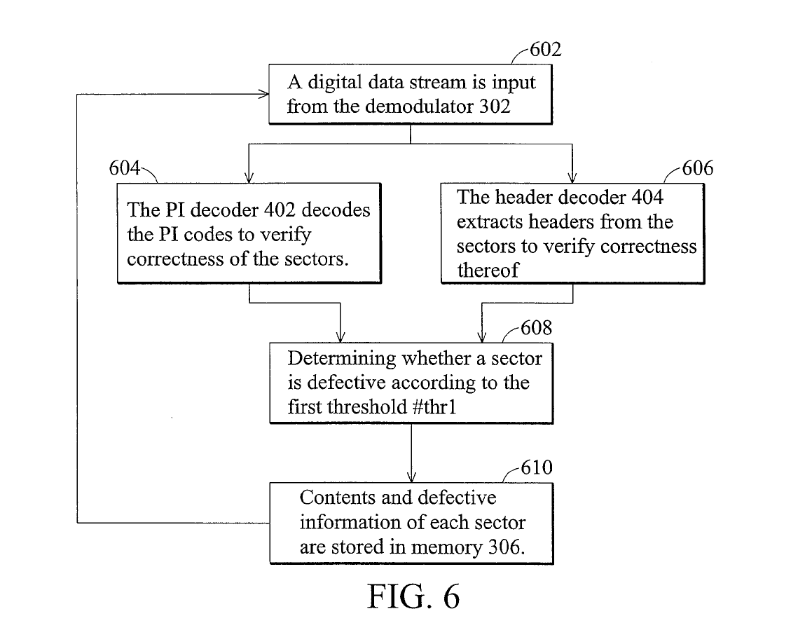

FIG. 6 is a flowchart of sector verification performed by the sector detector 304. In step 602, a digital data stream is input from the demodulator 302, comprising a plurality of sectors corresponding to an ECC block along with parity inner (PI) and parity outer (PO) codes. In step 604, the PI decoder 402 decodes the PI codes to verify correctness of the sectors. The header decoder 404 extracts headers from the sectors to verify correctness thereof in step 606. In step 608, the verification results of the contents are calculated and compared with a first threshold #thr1, such that defective information indicating whether a sector is defective is generated. In step 610, contents and defective information of each sector are stored in memory 306.

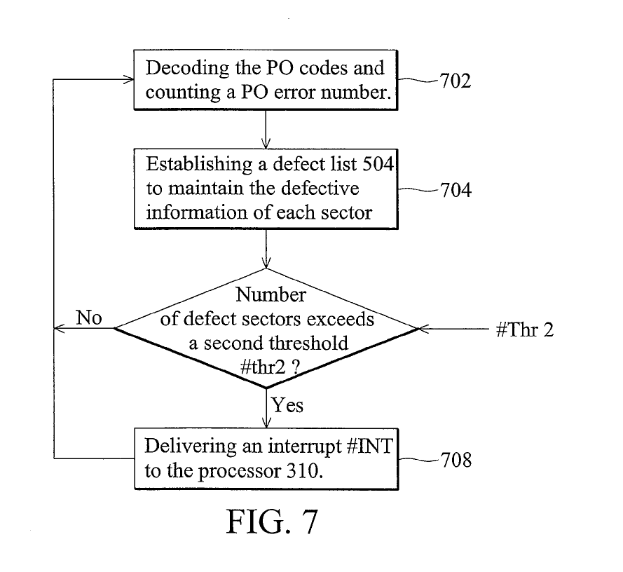

FIG. 7 is a flowchart of ECC block verification performed by the ECC block detector 308. In step 702, the sectors are read from the memory 306 to decode the PO codes, such that a PO error number is counted. In step 704, a defect list 504 is established to maintain the defective information of each sector within the ECC block. In step 706, number of defect sectors listed in the defect list 504 is counted and compared with the second threshold #thr2. If the number of defect sectors exceeds the second threshold #thr2, step 708 is processed, delivering an interrupt #INT to the processor 310, and suspending the PO decoding until the processor 310 completes a PDL/SDL management procedure. Otherwise, the process returns to step 702.

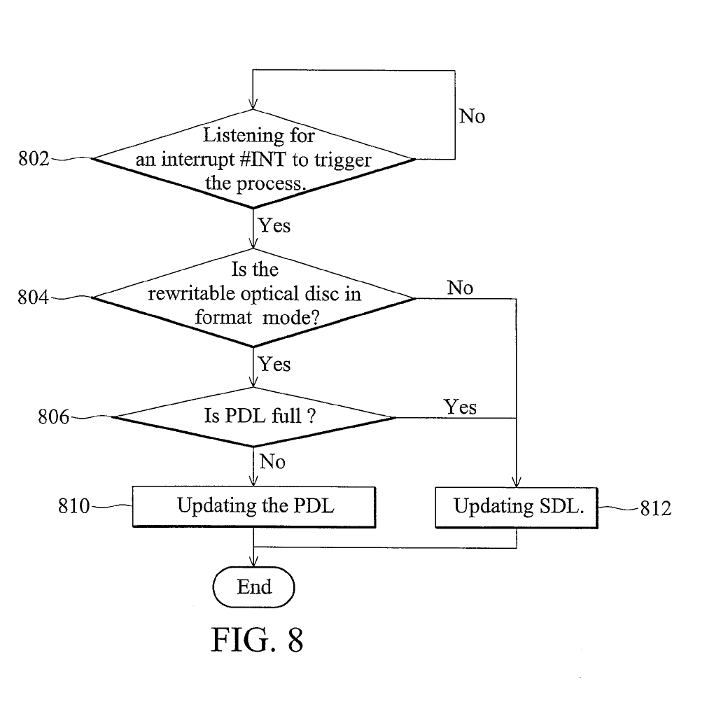

FIG. 8 is a flowchart of disc verification process according to an embodiment of the invention. In step 802, the processor 310 awaits an interrupt #INT to trigger the process. If an interrupt #INT is received, step 804 is processed, determining whether the rewritable optical disc is being formatted or written. In write mode, the process goes to step 812, updating SDL of the rewritable optical disc to record the defect ECC block. In format mode, capacity of the PDL on the rewritable optical disc is checked in step 806. If the PDL is full, step 812 is processed. Otherwise, the process goes to step 810, updating the PDL according to the defect list 504. In step 820, the disc verification process is concluded.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A defect detection system for rewritable optical discs, comprising:
a demodulator, reading an optical disc to obtain a plurality of sectors along with parity inner (PI);
a sector detector, coupled to the demodulator, decoding the PI codes to obtain defect information of the sectors;
a memory, coupled to the sector detector, assembling the sectors to form an ECC block with parity outer (PO) codes, and storing defect information of the sectors;
an ECC block detector, coupled to the memory, decoding the PO codes and determining defectiveness of the ECC block based on the defect information and the PO codes; and
a processor, coupled to the sector detector and ECC block detector, controlling the PI and PO decoding procedures.

2. The defect detection system as claimed in claim 1, wherein the sector detector comprises:
a PI decoder, verifying contents of the sectors based on the PI codes;
a header decoder, extracting headers from the sectors to verify correctness thereof; and
a sector verifier, coupled to the PI decoder and header decoder, counting the verification results from the PI decoder and header decoder, and determining whether a sector is defective based on the counting and a first threshold; wherein the sector detector stores the contents and defect information of each sector to the memory.

3. The defect detection system as claimed in claim 2, wherein:
a sector comprises a plurality of frames, each associated with a PI code;
the PI decoder determines the defectiveness of the frames based on the corresponding PI codes, and calculates a defect frame number for each sector;
if the defect frame number of a sector exceeds the first threshold, the sector is deemed defective; and
the first threshold is a programmable value implemented by software.

4. The defect detection system as claimed in claim 1, wherein the ECC block detector comprises:
a PO decoder, reading the sectors from the memory to decode the PO codes, and calculating a PO error number;
a defect list, maintaining the defectiveness determination results of the sectors, and
an ECC block verifier, coupled to the PO decoder and defect list, reading the defect list to calculate defect sector numbers, and determining whether the ECC block is defective by comparing the defect sector number and a second threshold.

5. The defect detection system as claimed in claim 4, wherein:
when the ECC block is deemed defective, the ECC block verifier delivers an interrupt to the processor to update a PDL or a SDL of the optical disc, and simultaneously, the ECC block verifier delivers a control signal to suspend the PO decoder until the processor completes the update; and
while the update is processing, the demodulator and sector detector continuously perform operations for another plurality of sectors of a next ECC block.

6. The defect detection system as claimed in claim 4, wherein:
if the defect sector number exceeds the second threshold, the ECC block is deemed defective; and
the second threshold is a programmable value implemented by software.

7. A defect detection method for rewritable optical discs, comprising:
reading an optical disc to sequentially obtain a plurality of sectors along with parity inner (PI);
decoding the PI codes to obtain defect information of the sectors;
buffering the sectors and defect information in a memory, from which an ECC block along with parity outer (PO) codes is reorganized;
upon the ECC block is reorganized, decoding the PO codes thereof;
determining defectiveness of the ECC block based on the defect information and the PO codes; and
when the ECC block is deemed defective, delivering an interrupt to update a PDL or a SDL of the optical disc.

8. The defect detection method as claimed in claim 7, wherein decoding of PI codes comprises:
verifying contents of the sectors based on the PI codes;
extracting headers from the sectors to verify correctness thereof; and
calculating the verification results of the contents and headers, and determining whether a sector is defective based on the calculation and a first threshold.

9. The defect detection method as claimed in claim 8, wherein:
a sector comprises a plurality of frames, each associated with a PI code;
verification of each sector comprises:
determining defectiveness of the frames based on the corresponding PI codes; and
calculating defect frame number for each sector;
wherein, if the defect frame number of a sector exceeds the first threshold, the sector is deemed defective; and
the first threshold is a programmable value implemented by software.

10. The defect detection method as claimed in claim 7, wherein PO decoding comprises:
reading the sectors from the memory to decode the PO codes, and calculating a PO error number;
establishing a defect list to maintain the defective information of each sector within the ECC block;
calculating the number of defect sectors listed in the defect list; and
determining whether the ECC block is defective by comparing the defect sector number and a second threshold.

11. The defect detection method as claimed in claim 10, wherein:
when the interrupt is delivered, the PO decoding is suspended until the update is complete; and
the PI decoding is continuously processed while the PO decoding is suspended.

12. The defect detection method as claimed in claim 10, wherein:
if the defect sector number exceeds the second threshold, the ECC block is deemed defective; and
the second threshold is a programmable value implemented by software.

13. A disc verification method for a rewritable optical disc, comprising:
reading the rewritable optical disc to sequentially obtain a plurality of sectors along with parity inner (PI);
upon an ECC block along with parity outer (PO) codes is reorganized from the sectors, determining defectiveness thereof, and
if a defectiveness is found, delivering an interrupt to trigger an update process, wherein:
the update process comprises:
if the disc verification method is performed in format mode, checking whether a PDL in the rewritable optical disc is full, if not, updating the PDL to record defect sectors in the ECC block, otherwise, updating the SDL to record the defect ECC block; and
if the disc verification method is performed in write mode, updating the SDL to record the defect ECC block.

14. The disc verification method as claimed in claim 13, wherein determination of the ECC block comprises:
decoding the PI codes to obtain defect information of the sectors;
buffering the sectors and defect information in a memory, in which the sectors reorganize the ECC block;
decoding the PO codes of the ECC block, and determining defectiveness of the ECC block based on the defect information and the PO codes; wherein:
the interrupt is delivered when the ECC block is deemed defective;
the reading and PI decoding are recursively performed.

15. The disc verification method as claimed in claim 14, wherein decoding of PI codes comprises:
verifying contents of the sectors based on the PI codes;
extracting headers from the sectors to verify correctness thereof; and
counting the verification results of the contents and headers, and determining whether a sector is defective based on the counting and a first threshold.

16. The disc verification method as claimed in claim 15, wherein:
a sector comprises a plurality of frames each associated with a PI code;
verification of each sector comprises:
determining defectiveness of the frames based on the corresponding PI codes; and
calculating defect frame number for each sector;
if the defect frame number of a sector exceeds the first threshold, the sector is deemed defective; and
the first threshold is a programmable value implemented by software.

17. The disc verification method as claimed in claim 14, wherein PO decoding comprises:
reading the sectors from the memory to decode the PO codes, and calculating a PO error number;
establishing a defect list to maintain the defective information of each sector within the ECC block;
calculating number of defect sectors listed in the defect list; and
determining whether the ECC block is defective by comparing the defect sector number and a second threshold.

18. The disc verification method as claimed in claim 14, wherein:
when the interrupt is delivered, the PO decoding is suspended until the update is complete; and
the PI decoding is continuously processed while the PO decoding is suspended.

19. The disc verification method as claimed in claim 14, wherein:
if the defect sector number exceeds the second threshold, the ECC block is deemed defective; and
the second threshold is a programmable value implemented by software.
